(19) United States
(12) Patent Application Publication
(10) Pub. No.: US 2026/0308968 A1
(43) Pub. Date: Oct. 8, 2026

(54) OPENING A MOTOR VEHICLE DOOR USING A DEPLOYMENT DEVICE

(71) Applicant: Brose Schließsysteme GmbH & Co. Kommanditgesellschaft, Wuppertal (DE)

(72) Inventors: Mike ROCKE, Heiligenhaus (DE); Niklas VOLLMERING, Köln (DE); Felix PANUSCH, Bamberg (DE); Abdelali EL-HAMOUMI, Wuppertal (DE)

(21) Appl. No.: 19/474,870

(22) PCT Filed: Apr. 11, 2024
(86) PCT No.: PCT/EP2024/059852

§ 371 Date: Nov. 5, 2025

(30) Foreign Application Priority Data
Apr. 13, 2023 (DE) 10 2023 109 319.3

(51) Int. Cl. E05F 15/622

(52) U.S. Cl. CPC E05F 15/622; E05Y 2400/612; E05Y 2900/531

(57) ABSTRACT

A deployment device for a motor vehicle door, having an extension element for deploying a motor vehicle door, an actuator unit, a holding structure and an energy store. The holding structure is designed to fasten the deployment device to a movable motor vehicle door or a fixed vehicle body region. The extension element is held on the holding structure movably over an extension distance between a retracted position and an extended position. The actuator unit has an electric drive for extending the extension element. The energy store is designed to store electrical energy and to provide electrical energy for at least emergency operation of the actuator unit. The energy store is accessible via the extension element.

### FIELD OF THE INVENTION

The present invention relates to the process of opening a motor vehicle door, and in particular to a deployment device for a motor vehicle door, to a motor vehicle door module, and to a method for opening a motor vehicle door.

### BACKGROUND OF THE INVENTION

For example, door deployment means are provided in motor vehicle doors to open vehicle doors wide enough for a user to reach behind the door to open it further, and therefore a separate handle does not need to be provided on the outside. For example, DE 10 2020 113728 A1 describes opening the vehicle door into a slightly deployed position. However, it has been found that, due to the lack of an external handle, further measures may be necessary in order to be able to open the vehicle door from the outside—for example, in the event of an accident.

### SUMMARY OF THE INVENTION

One object of the present invention is therefore to provide a deployment device with improved operation.

This object is achieved by the subject matter of the independent claims. Further examples are given in the dependent claims. The aspects described below also apply to the deployment device for a motor vehicle door, to the motor vehicle door module, and to the method for opening a motor vehicle door.

According to the invention, a deployment device for a motor vehicle door is provided. The deployment device has an extension element for deploying a motor vehicle door, an actuator unit, a holding structure, and an energy store. The holding structure is designed to fasten the deployment device to a movable motor vehicle door or a fixed vehicle body region. The extension element is held on the holding structure such that it can move over an extension distance between a retracted position and an extended position. The actuator unit has an electric drive for extending the extension element. The energy store is designed to store electrical energy and to provide electrical energy for at least emergency operation of the actuator unit. The energy store is accessible via the extension element.

This offers the advantage, for example, that the energy store, e.g., a battery, can be easily replaced because the extension element, e.g., a push rod of the door deployment means, is easily accessible. A special service flap in the door panel or the like is not necessary, for example.

According to one example, the energy store is arranged in the extension element.

According to one example, the energy store is accessible via a closable opening in the extension element.

According to one example, the energy store is accessible when the extension element is in the extended position.

According to one example, the energy store is replaceable.

As an option, the energy storage unit is replaceable when the extension element is in the extended position.

According to one example, the actuator unit has a spindle drive with a spindle, by means of which the extension element can be moved. The spindle is designed as a hollow spindle having a cavity that extends in the longitudinal direction and in which the energy store is removably held.

According to one example, the energy store is designed as a battery arrangement, an accumulator arrangement, and/or a capacitor arrangement.

According to one example, the energy store is designed as an emergency power supply for the actuator unit if the actuator unit is temporarily not supplied with energy by the vehicle's own electrical system, for example.

As an option, a monitoring unit is provided which is designed to monitor the state of charge of the energy store and to indicate at least a need to replace the energy store.

According to the invention, a motor vehicle door module is also provided. The motor vehicle door module has a deployment device according to any one of the preceding examples and a support structure for a motor vehicle door. The deployment device is held on the support structure. The extension element is designed to rest upon a stationary body region of a motor vehicle.

According to the invention, a method for opening a motor vehicle door is also provided. The method includes the following steps:
providing an extension element for deploying a motor vehicle door, an actuator unit having an electric drive for extending the extension element, a holding structure, and an energy store in which electrical energy is stored, wherein the energy store is accessible via the extension element; the extension element is held on the holding structure such that it can move over an extension distance between a retracted position and an extended position, and the holding structure fastens the deployment device to a movable motor vehicle door or a stationary body region;
supplying electrical energy from the energy store at least for emergency operation of the actuator unit; and
extending the extension element over at least some of the extension distance, and thereby at least slightly deploying the motor vehicle door.

The actuator is, for example, an electrical actuator, e.g., in the form of a linearly operable electromagnetic actuator (electromagnetic actuating mechanism) or as a rotationally operable electromagnetic actuator (electric motor).

According to one aspect of the invention, an energy store is provided for a vehicle door deployment device, which can effect emergency opening in the event of a power supply to the deployment device no longer being available, by the deployment device executing at least some of the otherwise usual distance so that the door can be opened further-for example, by rescue workers. The energy store is accessible via the extension element so that no further measures are required at the door, in order to replace the energy store, e.g., a battery, without great effort. A deployment device with an integrated energy store is provided.

It should be noted that the features of the exemplary embodiments of the deployment device for a motor vehicle door also apply to embodiments of the motor vehicle door module and the method for opening a motor vehicle door, and vice versa. In addition, features may also be freely combined even if this is not explicitly stated.

### BRIEF DESCRIPTION OF THE DRAWINGS

In the following, exemplary embodiments of the invention will be discussed in more detail with reference to the accompanying drawings.

FIG. 1 is a schematic sectional view of an example of a deployment device having an energy store.

FIG. 2 is a schematic sectional view of an example of a motor vehicle door module having the deployment device from FIG. 1.

FIG. 3a and FIG. 3b are perspectival views of another example of a deployment device in a retracted (FIG. 3a) and an extended (FIG. 3b) position. In the extended position, access to the energy store is possible.

FIG. 4a and FIG. 4b are sectional views of the example from FIG. 3a and FIG. 3b.

FIG. 5a and FIG. 5b are sectional views of another example of a deployment device in a retracted (FIG. 5a) and an extended (FIG. 5b) position. Access to the energy store is possible via the end face.

FIG. 6a and FIG. 6b show another example of a deployment device in a sectional view (FIG. 6a) and in a perspectival view (FIG. 6b). The energy store is arranged in a hollow spindle. Access to the energy storage unit is also possible via the end face, for example.

FIG. 7a and FIG. 7b are sectional views of an example of a deployment device having flexible cable routing to the energy store in a retracted (FIG. 7a) and an extended (FIG. 7b) position.

FIG. 8a and FIG. 8b are sectional views of an example of a deployment device with sliding contacts for electrically connecting the energy store in a retracted (FIG. 8a) and an extended (FIG. 8b) position.

FIG. 9 shows enlarged cutouts of the example from FIG. 8A.

FIG. 10 shows an enlarged cutout from FIG. 9.

FIG. 11 shows an example of a method for opening a motor vehicle door.

### DETAILED DESCRIPTION OF EMBODIMENTS

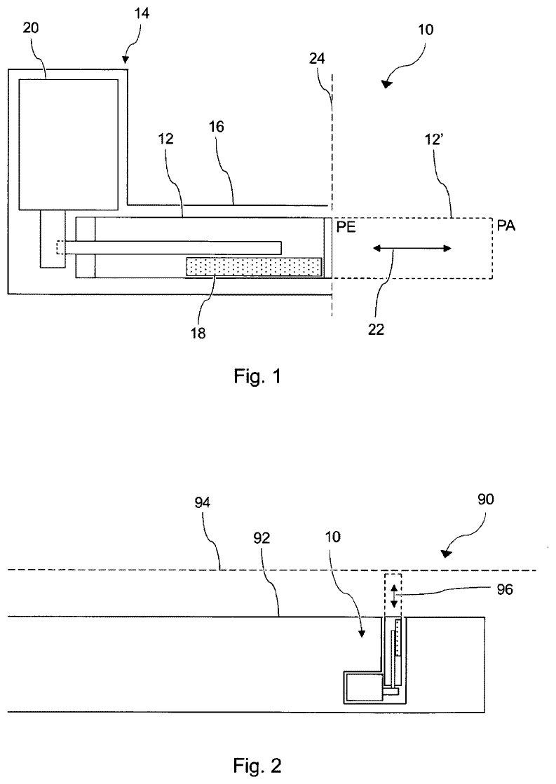

FIG. 1 is a schematic sectional view of an example of a deployment device 10 having an energy store. The deployment device 10 has an extension element 12 for deploying a motor vehicle door, an actuator unit 14, a holding structure 16, and an energy store 18. The holding structure is designed to fasten the deployment device to a movable motor vehicle door or a fixed vehicle body region. The extension element 12 is held on the holding structure such that it can move over an extension distance between a retracted position PE and an extended position PA. The actuator unit 14 has an electric drive 20 for extending the extension element 12. The energy store 18 is designed to store electrical energy and to provide it at least for emergency operation of the actuator unit 14. The energy store 18 is accessible via the extension element 12. A double-headed arrow 22 indicates the movement of the extension element 12 along the extension distance.

The extension element 12 can also be referred to as a transmission element since it transmits a force for deploying the vehicle door between the vehicle door and a stationary body region.

The actuator unit 14 is an electric drive for extending and retracting the extension element 12.

One option includes a deployment device for a motor vehicle door. The deployment device has an extension element for deploying a motor vehicle door, an actuator unit, a holding structure, and an energy store. The holding structure is designed to fasten the deployment device to a movable motor vehicle door or a fixed vehicle body region. The extension element is held on the holding structure such that it can move over an extension distance between a retracted position and an extended position. The actuator unit is an electric drive for extending the extension element. The energy store is designed to store electrical energy and to provide electrical energy for at least emergency operation of the actuator unit. In this option, the energy store is arranged in the extension element.

The energy store 18 provides, for example, electrical redundancy, e.g., after a crash, i.e., an accident. The energy store 18 can be designed as a battery that is regularly replaced during service. For push-out units with integrated control, the battery can also be integrated into the push-out unit. The battery is accessible via the extension element 12. This makes it easier to change the battery, for example.

For example, the battery is housed in the push rod of the push-out unit and is easily accessible in the extended position.

FIG. 2 is a schematic sectional view of an example of a motor vehicle door module 90 having the deployment device from FIG. 1. The motor vehicle door module 90 has an example of the deployment device 10 according to any one of the examples above or below. The motor vehicle door module 90 also has a support structure 92 for a motor vehicle door. The deployment device 10 is held on the support structure 92. The extension element 12 is designed to rest upon a stationary body region 94 (indicated as a dashed line) of a motor vehicle. A double-headed arrow 96 indicates the movement of the extension element 12 along the extension distance.

As an option, a motor vehicle door frame module is provided which has a deployment device according to any one of the examples mentioned above or below, as well as a stationary body region provided as a door frame. The deployment device is held on the stationary body region. The extension element is designed to rest upon a motor vehicle door—for example, a support structure of the motor vehicle door.

As a further option, a motor vehicle door module is provided, which has a motor vehicle lock module according to the aforementioned option, as well as a support structure for a motor vehicle door. The deployment device is held on the support structure. The extension element 12 is designed to rest upon a stationary body region of a motor vehicle.

As an additional option, a motor vehicle door frame module is provided, which has a motor vehicle lock module according to the option mentioned above, as well as a stationary body region provided as a door frame. The deployment device of the motor vehicle lock module is held on the stationary body region. The extension element 12 is designed to rest upon a motor vehicle door—for example, a support structure of the motor vehicle door.

As shown in the following examples, an option provides that the energy store 18 be arranged in the extension element 12.

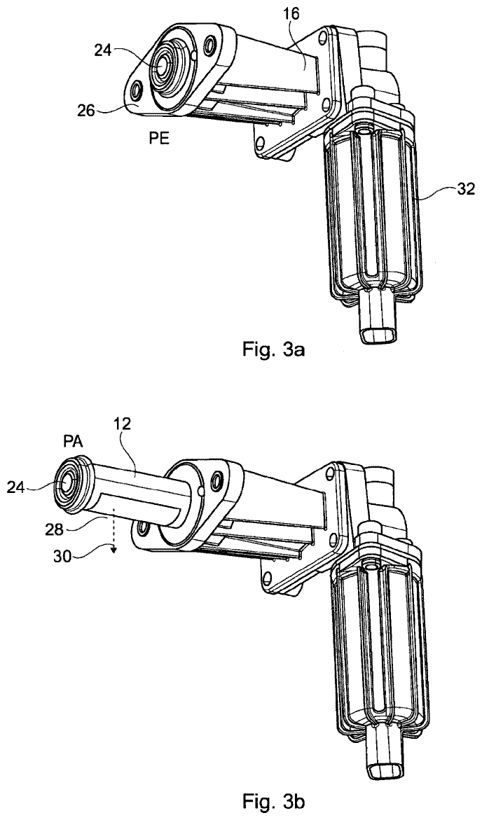

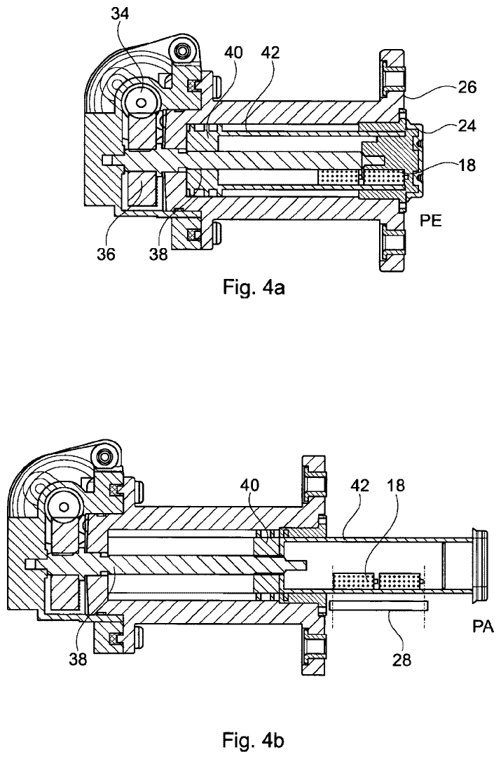

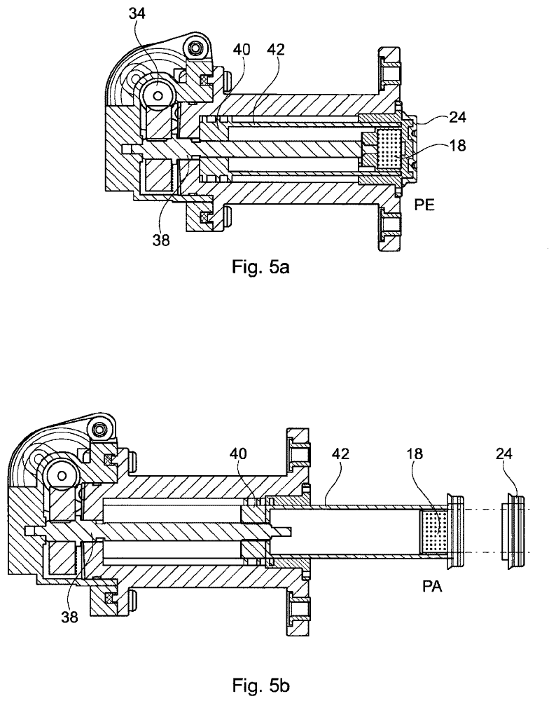

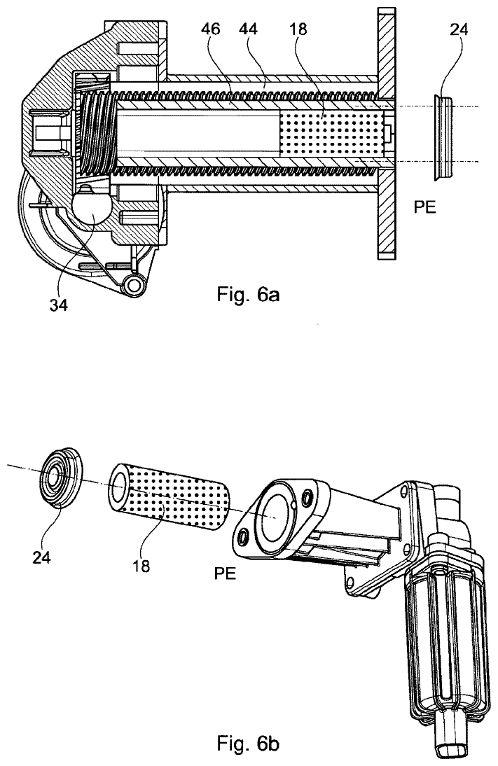

As also shown in the following examples, a further, i.e., additional or alternative, option provides that the energy store 18 be accessible via a closable opening in the extension element 12; see, for example, FIG. 3b, FIG. 4b, FIG. 5b, and FIG. 6b.

As an option, the energy store 18 is arranged in a splash-proof receptacle.

For example, a movable or removable cover cap for a battery compartment is provided on the side of the push rod as a closable opening. In another example, the movable or removable cover cap of the battery compartment is located at the head end of the push rod; see, for example, FIG. 5a, FIG. 5b, FIG. 6a, or FIG. 6b.

As also shown in the following examples, a further, i.e., additional or alternative, option provides that the energy store 18 be accessible when the extension element 12 is in the extended position; see, for example, FIG. 3b or FIG. 4b.

In one example, with a spindle drive, it is provided for a battery to be housed in a battery compartment in such a way that the battery is located next to the spindle when viewed in the radial direction. The battery is then changed when the push rod, i.e., the extension element 12, is in the extended position. In this variant, the battery size and shape are defined according to the free cavity between the spindle and the inner wall of the extension element 12.

In one example, a battery compartment is provided at the head end of the push rod. The battery can then be changed with the push rod in either the retracted or extended position. In this variant, the battery size and shape are defined according to the possible battery compartment.

As also shown in the following examples, a further, i.e., additional or alternative, option provides that the energy store 18 be replaceable; see, for example, FIG. 3b, FIG. 4b, FIG. 5b, or FIG. 6b.

As an option, the energy store 18 is replaceable when the extension element 12 is in the extended position; see, for example, FIG. 3b or FIG. 4b.

In one example, the energy store 18 can be replaced via a closable opening when the extension element 12 is in the extended position.

The replaceability of the energy store 18, e.g., a battery, makes it possible, for example, to easily change it during a service visit to a workshop or at any other point in time. A further advantage is that an additional access in, for example, the interior door panel or an additional opening in the door panel for access to the battery is not required.

As also shown in the following examples, a further, i.e., additional or alternative, option provides that the energy store 18 be accommodated in a storage region and, when installed, be accessible in the extended position from below; see, for example, FIG. 3b or FIG. 4b.

For example, a removable cover is provided that frees an opening that is accessible from below.

As also shown in the following examples, a further, i.e., additional or alternative, option provides that the extension element 12 have a cavity in which the energy store 18 is removably held.

In another example, a battery compartment is located in a hollow body of the push rod-for example, in a push rod concept that has an external spindle nut contour and a hollow rod. The battery is then changed with the push rod in either the retracted or extended position. In this variant, the battery size and shape are defined according to the cavity provided.

FIG. 3a and FIG. 3b are perspectival views of another example of the deployment device 10 in the retracted state, i.e., the retracted position PE, in FIG. 3a and in the extended state, i.e., the extended position PA, in FIG. 3b. The extension element 12 has, for example, a front cap 24 for abutting the body region (or the vehicle door if the deployment device 10 is held on the body region). The holding structure 16 may, for example, have a front flange 26 for fastening to a supporting panel, with a recess through which the extension element 12 can protrude during retraction and extension.

FIG. 3b shows an openable covering 28, which is provided on the extension element 12. An arrow 30 indicates the opening process. The covering 28 can, for example, be completely removed or can be open. In the extended position PA, access to the energy store 18 is possible in any case. For example, the energy store 18, e.g., a battery, can be replaced.

In FIG. 3a and FIG. 3b, the electric drive is indicated with a housing structure 32.

It should be noted that the examples all show a drive arranged transversely to the extension direction. However, it is also provided that the drive be arranged parallel to the extension direction, or in a different design. In addition to the variants shown with a gear between the drive and the extension element 12, designs can also be provided in which the drive acts directly upon the extension element 12. Instead of a gear, other transmission elements can also be provided, such as actuating mechanisms in the form of rods or Bowden cables and the like.

FIG. 4a and FIG. 4b are sectional views of the example from FIG. 3a and FIG. 3b.

The extension element 12 is designed to have a spindle drive. An electric motor acts via an output element 34 in the form of a worm gear on a gear wheel 36, provided on the end face, of a spindle rod 38. The extension element 12 is held such that it cannot rotate, but can move in a linear fashion and has at the left end a spindle nut 40 which engages with the spindle rod 38. The extension element 12 then continues as a hollow cylinder 42, at the right end of which the front cap 24 is provided.

By rotating the spindle rod 38, the extension element 12 is moved back and forth, i.e., along the extension distance between the retracted position PE and the extended position PA.

In the example shown in FIG. 4a and FIG. 4b, the energy store 18 is shown in the form of two energy storage units, e.g., two batteries, which are held inside the hollow cylinder 42 on the inner wall thereof so that they do not interfere with the spindle rod 38.

In one variant (not shown in more detail), the energy store 18 is an accumulator which is designed as a cylinder with a central recess in order to make optimum use of the space and so that the spindle rod 38 can move unhindered in the recess during retraction and extension.

FIG. 5a and FIG. 5b are sectional views of another example of a deployment device in a retracted and an extended position. Access to the energy store 18 is possible via the end face. For this purpose, for example, the front cap 24 is designed to be removable. The energy store 18 is designed as a compact cylindrical block in the front end of the hollow cylinder 42. Access and thus, for example, replacement are possible via the removable front cap 24, as indicated in FIG. 5b.

In one variant, access is possible only in an at least partially extended position-for example, when a laterally accessible locking mechanism of the removable front cap 24 is accessible and releasable.

In one variant, access is possible regardless of the position of the extension element 12—for example, if the removable front cap 24 can be removed from the front.

The energy store 18 can also be designed in a similar manner to the energy store 18 in FIG. 4a and FIG. 4b, or also as a cylindrical body with a central recess for the spindle rod 38.

As also shown in the following examples, a further, i.e., additional or alternative, option provides that the actuator unit 14 have a spindle drive with a spindle used to move the extension element. The spindle is designed as a hollow spindle with a cavity that extends in the longitudinal direction and in which the energy store 18 is removably held; see, for example, FIG. 6a.

For example, the extension element has a spindle counterpart that engages with the spindle.

FIG. 6a and FIG. 6b show another example of the deployment device 10 in a sectional view in FIG. 6a and in a perspectival view in FIG. 6b.

The extension element 12 is driven by a spindle drive which is driven by the electric drive via a worm gear 34. However, in the example, a hollow spindle 44 is provided which has an internal thread over its entire length. The extension element 12 is used as a hollow spindle counterpart 46 and has a suitable external thread at least at the left end or even throughout, and is held such that it cannot rotate, but can move in a linear fashion.

The energy store 18 is arranged in the hollow spindle counterpart 46 and is moved back and forth together therewith within the hollow spindle. Access to the energy store 18 is, for example, also possible via the end face—for example, via the removable front cap 24.

In one variant, access is possible only in an at least partially extended position—for example, when a laterally accessible locking mechanism of the removable front cap 24 is accessible and releasable.

In one variant, access is possible regardless of the position of the extension element 12—for example, if the removable front cap 24 can be removed from the front.

In one variant (not shown in more detail), a spindle drive is provided which has a spindle with a longitudinally extending cavity in which the energy store 18 is arranged. The extension element is designed as a cylindrical body that encloses the spindle with the cavity. In this case, the energy store 18 is not moved in the longitudinal direction when the extension element 12 is extended and retracted, but rotates together with the spindle. In this case, sliding contacts are ideal for transmitting electrical energy.

As also shown in the following examples, a further, i.e., additional or alternative, option provides that at least one flexible cable connection be provided for connecting the energy store 18 to the electric drive 20.

As an option, it is provided that the holding structure 16 have at least one lateral recess in the region of a guide for the extension element 12, which recess forms a receiving region for a cable region when the extension element is retracted.

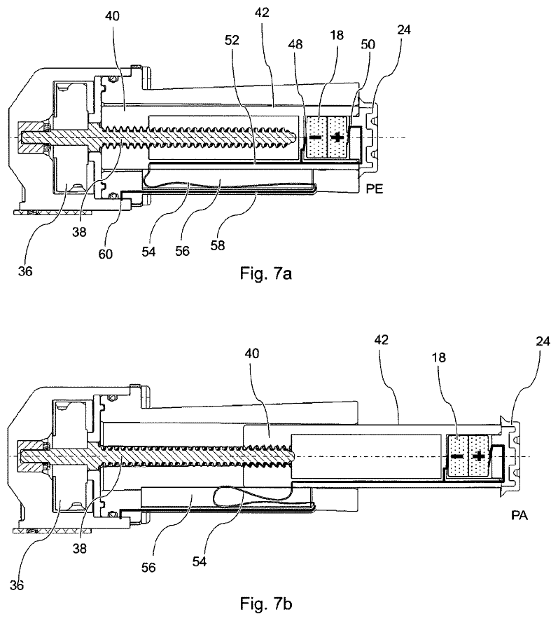

FIG. 7a and FIG. 7b are sectional views of an example of the deployment device 10 having flexible cable routing to the energy store 18. The energy store 18 is arranged here, for example, in the front region of the extension element 12—for example, as one or more batteries. For connecting the batteries, for example, a first spring terminal 48 is provided for connection to one pole of the battery—for example, the negative pole. For connection to the other pole, e.g., the positive pole, a further contact, e.g., a second spring terminal 50, is provided, which is held, for example, by the front cap 24. Lines 52 run from the two contact points in the direction of the drive—for example, in the wall of the hollow cylinder 42 of the extension element 12. In the rear region, i.e., in the left region in the drawing, the lines 52 emerge from the wall, where they are designed as flexible lines 54 which, in the retracted position, are accommodated, i.e., stowed, in a recess 56 in the housing structure. At the right end of the recess 56, the flexible lines 54 enter the housing walls and run back to the left as embedded lines 58. At the left end, a connector 60 is provided for connection to the electric motor, i.e., the electric drive.

FIG. 7b shows how the flexible lines 54 can run to the right in the recess 56 when the extension element extends toward the extended position PA.

In further variants, the energy store 18 is provided in one of the variants described above. Depending upon the type, shape, and arrangement of the energy store 18, a different location of contact then results, but the routing of the flexible lines 54 in the cavity is, analogously, provided.

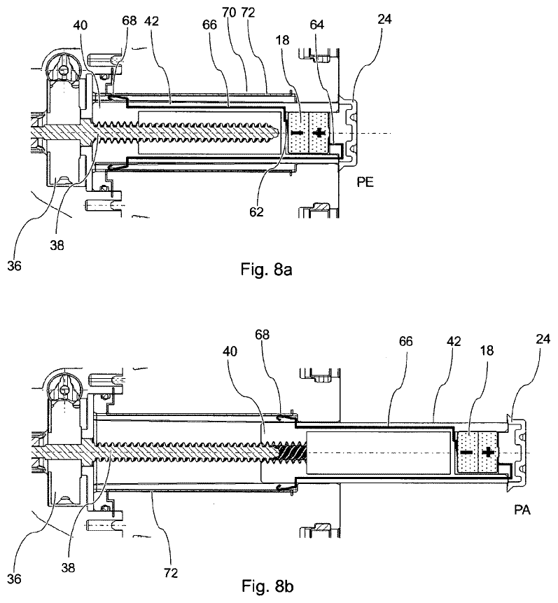

As also shown in the following examples, a further, i.e., additional or alternative, option provides that at least one sliding contact be formed between the extension element 12 and the holding structure 16 in order to provide electrical energy from the energy store 18 to the actuator unit 14 when the extension element 12 moves; see, for example, FIG. 8a and FIG. 8b.

One option provides a combination of one or more sliding contacts and one or more flexible cable connections each having lateral recesses.

FIG. 8a and FIG. 8b are sectional views of an example of a deployment device with sliding contacts for electrically connecting the energy store 18 in the retracted position PE and the extended position PA. The energy store 18 is arranged here, for example, in the front region of the extension element 12—for example, as one or more batteries. For connecting the batteries, a first spring terminal 62, for example, is provided for connection to one pole of the battery—for example, the negative pole. For connection to the other pole, e.g., the positive pole, a further contact, e.g., a second spring terminal 64, is provided, which is held, for example, by the front cap 24. Lines 66 run from the two contact points—for example, in the wall of the hollow cylinder 42 of the extension element 12. In the left region of the hollow cylinder 42, the lines 66 emerge from the hollow cylinder 42 as sliding contacts 68. Contact tracks 72 are provided on an inner wall 70 of the housing, against which tracks the sliding contacts 68 rest when the extension element 12 moves back and forth. At the left end of the contact tracks 72, a connector 74 is provided for connection to the electric motor, i.e., the electric drive.

In further variants, the energy store 18 is provided in one of the variants described above. Depending upon the type, shape, and arrangement of the energy store 18, a different location of contact then results, but the sliding contacts are, analogously, provided.

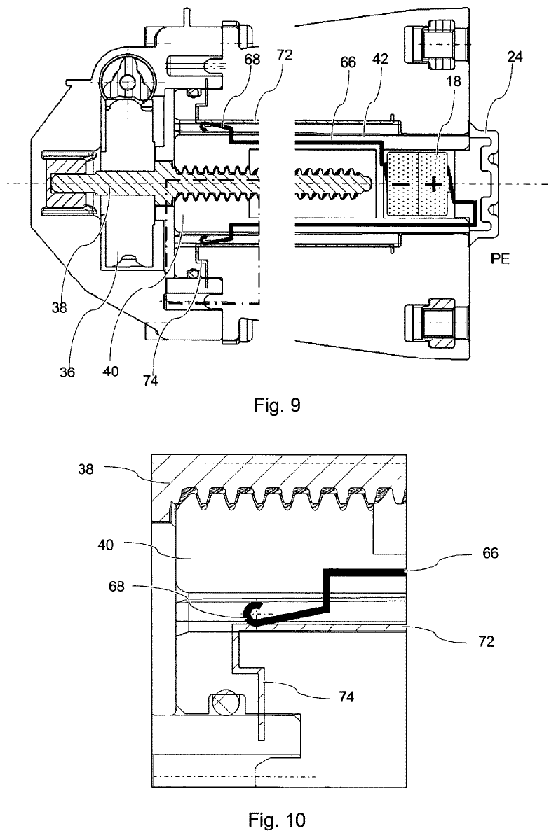

FIG. 9 shows an enlarged cutout of the example from FIG. 8a.

### FIG. 10 shows a further enlarged cutout from FIG. 9.

A further, i.e., additional or alternative, option provides in a first variant that the energy store 18 be designed as a battery arrangement. As a second variant, it is provided that the energy store 18 be designed as an accumulator arrangement. As a third variant, it is provided that the energy store 18 be designed as a capacitor arrangement.

In an additional variant, a combination of the first variant with the second variant, or a combination of the first variant with the third variant, or a combination of the second variant with the third variant, or even a combination of the first variant with the second and the third variant is provided.

For example, the battery arrangement is a standard battery, such as a 9-V block battery. The battery arrangement is replaced, for example, during a workshop visit. The battery arrangement may have one or more batteries.

For example, the accumulator arrangement is adapted to the electrical energy supply to the actuator unit 14, e.g., to the voltage of the vehicle's on-board electrical system. For example, if a storage compartment is provided, the accumulator arrangement is adapted thereto. For example, the accumulator arrangement is charged at least during operation of the actuator unit 14. In one example, the accumulator arrangement is constantly charged. The accumulator arrangement is replaced, for example, during a workshop visit. The accumulator arrangement can also be designed as an accumulator or accumulator unit having a plurality of accumulators.

For example, the capacitor arrangement is adapted to the electrical energy supply of the actuator unit 14 and is charged during normal operation of the vehicle, at least during operation of the actuator unit 14, in order to be supplied with sufficient energy to open the vehicle door, at least slightly, in an emergency if the on-board electrical system fails, or the actuator unit 14 is no longer supplied with electrical energy by the on-board electrical system. In one example, the capacitor arrangement is constantly charged. The capacitor arrangement is replaced, for example, during a workshop visit. The capacitor arrangement can also be designed as a capacitor or capacitor unit having a plurality of capacitors.

A further, i.e., additional or alternative, option, provides that the energy store 18 be designed as an emergency power supply for the actuator unit 14 if the actuator unit 14 is not supplied by the vehicle's own electrical system.

As an option, a monitoring unit is preferably provided, which is designed to monitor the state of charge of the energy store 18 and to indicate at least a need to replace the energy store 18.

For example, it is provided that the energy store 18 be provided as an emergency power supply for the actuator unit 14 if the connection to the on-board electrical system is interrupted, or the on-board electrical system has partially or completely failed. The interruption or failure may, for example, be caused by an accident.

In one option, it is provided that the emergency power supply provided by the energy store 18 be designed to extend the extension element 12 over a portion of the extension distance and to slightly open the vehicle door.

For example, in the emergency operating mode, the vehicle door is opened only some of the usual opening width of the deployment device 10, e.g., 20 to 30 mm, or up to 40 mm, instead of, for example, an extension distance of 70 mm.

A further, i.e., additional or alternative, option provides that the energy store 18 have a connector (not shown in more detail) for connection to an electric drive of a motor vehicle lock for emergency opening of the motor vehicle lock.

In one example, the energy store 18 of the deployment device for emergency opening of the motor vehicle lock is connected to the electric drive of the motor vehicle lock.

A further option provides a motor vehicle lock module. The motor vehicle lock module has a deployment device according to any one of the preceding examples and a motor vehicle lock having a locking mechanism and an electric drive for opening the locking mechanism. The energy store 18 of the deployment device is connected to the electric drive of the motor vehicle lock for emergency opening of the motor vehicle lock.

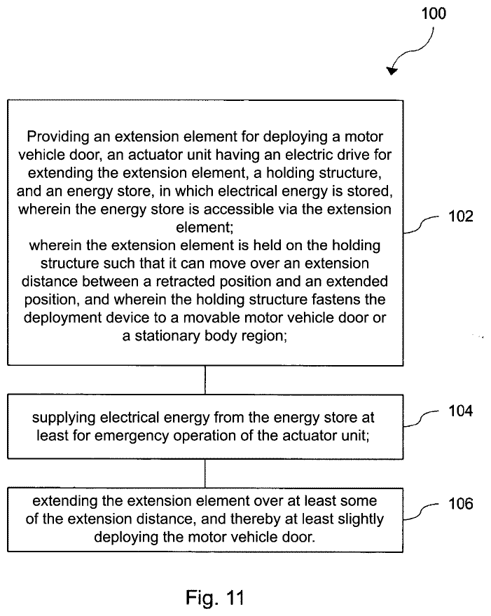

FIG. 11 shows an example of a method 100 for opening a motor vehicle door. The method 100 has the following steps:
providing 102 an extension element for deploying a motor vehicle door, an actuator unit having an electric drive for extending the extension element, a holding structure, and an energy store in which electrical energy is stored, wherein the energy store is accessible via the extension element; the extension element is held on the holding structure such that it can move over an extension distance between a retracted position and an extended position, and the holding structure fastens the deployment device to a movable motor vehicle door or a stationary body region;
supplying 104 electrical energy from the energy store at least for emergency operation of the actuator unit; and
extending 106 the extension element over at least some of the extension distance, and thereby deploying the motor vehicle door at least slightly.

The exemplary embodiments described above can be combined in different ways. In particular, aspects of the devices can also be used for the embodiments of the method, and vice versa.

It should also be noted that “comprising” does not exclude other elements or steps, and “a” or “one” does not exclude a plurality. Furthermore, it should be noted that features or steps described with reference to one of the above exemplary embodiments may also be used in combination with other features or steps of other exemplary embodiments described above. Reference signs in the claims are not to be considered restrictive.

1. A deployment device for a motor vehicle door, the deployment device having:
an extension element for deploying a motor vehicle door;
an actuator unit;
a holding structure; and
an energy store;
wherein the holding structure is designed to fasten the deployment device to a movable motor vehicle door or a stationary body region;
wherein the extension element is held on the holding structure such that it can move over an extension distance between a retracted position and an extended position;
wherein the actuator unit has an electric drive for extending the extension element;
wherein the energy store is designed to store electrical energy and to provide it at least for emergency operation of the actuator unit;
wherein the energy store is accessible via the extension element.

2. The deployment device according to claim 1, wherein the energy store is arranged in the extension element.

3. The deployment device according to claim 1, wherein the energy store is accessible via a closable opening in the extension element; and
wherein the energy store is arranged in a splash-proof receptacle.

4. The deployment device according to claim 1, wherein the energy store is accessible when the extension element is in the extended position.

5. The deployment device according to claim 1, wherein the energy store is replaceable;
wherein the energy store is replaceable when the extension element is in the extended position.

6. The deployment device according to claim 1, wherein the energy store is accommodated in a storage region and, when installed, is accessible in the extended position from below.

7. The deployment device according to claim 1, wherein the extension element has a cavity in which the energy store is removably held.

8. The deployment device according to claim 1, wherein the actuator unit has a spindle drive with a spindle with which the extension element can be moved; and
wherein the spindle is designed as a hollow spindle with a cavity that extends in the longitudinal direction and in which the energy store is removably held.

9. The deployment device according to claim 1, wherein at least one sliding contact is formed between the extension element and the holding structure in order to provide electrical energy from the energy store to the actuator unit when the extension element moves.

10. The deployment device according to claim 1, wherein at least one flexible cable connection is provided for connecting the energy store to the electric drive; and
wherein the holding structure has at least one lateral recess in the region of a guide for the extension element, which recess forms a receiving region for a cable region when the extension element is retracted.

11. The deployment device according to claim 1, wherein the energy store is designed as at least one from the group having:
a battery arrangement,
an accumulator arrangement, and
a capacitor arrangement.

12. The deployment device according to claim 1, wherein the energy store is designed as an emergency power supply for the actuator unit when the actuator unit is not supplied with energy by the vehicle's own electrical system; and
wherein a monitoring unit is provided which is designed to monitor the state of charge of the energy store and to indicate at least a need to replace the energy store.

13. The deployment device according to claim 1, wherein the energy store has a connector for connection to an electric drive of a motor vehicle lock for emergency opening of the motor vehicle lock.

14. A motor vehicle door module, having:
a deployment device according to claim 1; and
a support structure for a motor vehicle door;
wherein the deployment device is held on the support structure; and
wherein the extension element is designed to rest upon a stationary body region of a motor vehicle.

15. A method for opening a motor vehicle door, having the following steps:
providing an extension element for deploying a motor vehicle door, an actuator unit having an electric drive for extending the extension element, a holding structure, and an energy store in which electrical energy is stored, wherein the energy store is accessible via the extension element;
wherein the extension element is held on the holding structure such that it can move over an extension distance between a retracted position and an extended position, and wherein the holding structure fastens the deployment device to a movable motor vehicle door or a stationary body region;
supplying electrical energy from the energy store at least for emergency operation of the actuator unit; and
extending the extension element over at least some of the extension distance, and thereby at least slightly deploying the motor vehicle door.
